(19) United States
(12) Patent Application Publication
(10) Pub. No.: US 2025/0047585 A1
(43) Pub. Date: Feb. 6, 2025

(54) DETECTION DEVICE AND DETECTION METHOD

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventors: Kyosuke MASUKAWA, Osaka-shi, Osaka (JP); Hiroshi UEDA, Yokkaichi-shi, Mie (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/718,856

(22) PCT Filed: Dec. 9, 2022
(86) PCT No.: PCT/JP2022/045396

§ 371 Date: Jun. 12, 2024

(30) Foreign Application Priority Data
Dec. 28, 2021 (JP) 2021-214171

(51) Int. Cl. H04L 43/106; H04L 43/0876

(52) U.S. Cl. CPC H04L 43/106; H04L 43/0876

(57) ABSTRACT

Provided is a detection device that detects an abnormality in a network in which a plurality of messages including a periodic message are transmitted and received. The detection device includes: a calculation unit configured to calculate a detection index that increases and decreases according to a relationship between an observation result of the plurality of messages and reference information related to the observation result; a detection unit configured to perform a detection process of detecting an abnormality in the network, based on the detection index calculated by the calculation unit; and a reset unit configured to monitor the detection index, and reset the detection index to be used in the detection process, upon detecting an extremum of the detection index.

### TECHNICAL FIELD

The present disclosure relates to a detection device and a detection method.

This application claims priority on Japanese Patent Application No. 2021-214171 filed on Dec. 28, 2021, the entire content of which is incorporated herein by reference.

### BACKGROUND ART

PATENT LITERATURE 1 (International Publication No. WO2021/111685) discloses a detection device as follows. That is, the detection device is a device for detecting an unauthorized message in an in-vehicle network, and includes: an acquisition unit that acquires a target distribution that is a distribution of reception intervals of periodic messages transmitted in the in-vehicle network; an extraction unit that extracts a part of the target distribution acquired by the acquisition unit, in accordance with a predetermined criterion; and a detection unit that performs a detection process of detecting the unauthorized message, based on the part of the target distribution, extracted by the extraction unit.

### CITATION LIST

### Patent Literature

PATENT LITERATURE 1: International Publication No. WO2021/111685

### SUMMARY OF THE INVENTION

A detection device according to the present disclosure is a detection device that detects an abnormality in a network in which a plurality of messages including a periodic message are transmitted and received. The detection device includes: a calculation unit configured to calculate a detection index that increases and decreases according to a relationship between an observation result of the plurality of messages and reference information related to the observation result; a detection unit configured to perform a detection process of detecting an abnormality in the network, based on the detection index calculated by the calculation unit, and a reset unit configured to monitor the detection index, and reset the detection index to be used in the detection process, upon detecting an extremum of the detection index.

A detection method according to the present disclosure is a detection method in a detection device that detects an abnormality in a network in which a plurality of messages including a periodic message are transmitted and received. The detection method includes: calculating a detection index that increases and decreases according to a relationship between an observation result of the plurality of messages and reference information related to the observation result; performing a detection process of detecting an abnormality in the network, based on the calculated detection index; and monitoring the detection index, and resetting the detection index to be used in the detection process, upon detecting an extremum of the detection index.

An aspect of the present disclosure can be realized not only as a detection device including such a characteristic processing unit, but also as a program for causing a computer to execute steps of such characteristic processing, as a semiconductor integrated circuit that realizes a part or the entirety of the detection device, or as a system that includes the detection device.

### BRIEF DESCRIPTION OF DRAWINGS

FIG. 1 shows a configuration of a communication system according to an embodiment of the present disclosure.

FIG. 2 shows a configuration of a relay device according to the embodiment of the present disclosure.

FIG. 3 shows an example of target messages received by the relay device according to the embodiment of the present disclosure, and a distribution of reception times.

FIG. 4 shows an example of statistic values used for a detection process in the relay device according to the embodiment of the present disclosure.

FIG. 5 shows an example of target messages received by the relay device according to the embodiment of the present disclosure, and a distribution of reception times.

FIG. 6 shows an example of statistic values used for a detection process in a relay device according to a comparative example of the embodiment of the present disclosure.

FIG. 7 shows an example of statistic values used for a detection process in the relay device according to the embodiment of the present disclosure.

FIG. 8 shows another example of target messages received by the relay device according to the embodiment of the present disclosure, and a distribution of reception times.

FIG. 9 shows an example of statistic values used for a detection process in the relay device according to the embodiment of the present disclosure.

FIG. 10 shows another example of target messages received by the relay device according to the embodiment of the present disclosure, and a distribution of reception times.

FIG. 11 shows an example of statistic values used for a detection process in the relay device according to the embodiment of the present disclosure.

FIG. 12 is a flowchart showing an example of an operation procedure when the relay device according to the embodiment of the present disclosure performs a detection process.

FIG. 13 shows an example of a connection topology of a network according to the embodiment of the present disclosure.

FIG. 14 shows an example of the degree of abnormality calculated by a calculation unit in the relay device according to the embodiment of the present disclosure.

### DETAILED DESCRIPTION

To date, a technology for improving security in a network has been proposed.

### Problems to be Solved by the Present Disclosure

A technology enabling more accurate detection of an abnormality in a network is desired beyond the technology described in PATENT LITERATURE 1.

The present disclosure has been made to solve the above problem, and an object of the present disclosure is to provide a detection device and a detection method capable of more accurately detecting an abnormality in a network.

### Effects of the Present Disclosure

According to the present disclosure, it is possible to more accurately detect an abnormality in a network.

### Description of Embodiment of the Present Disclosure

First, contents of the embodiment of the present disclosure will be listed and described.
(1) A detection device according to an embodiment of the present disclosure is a detection device that detects an abnormality in a network in which a plurality of messages including a periodic message are transmitted and received. The detection device includes: a calculation unit configured to calculate a detection index that increases and decreases according to a relationship between an observation result of the plurality of messages and reference information related to the observation result; a detection unit configured to perform a detection process of detecting an abnormality in the network, based on the detection index calculated by the calculation unit; and a reset unit configured to monitor the detection index, and reset the detection index to be used in the detection process, upon detecting an extremum of the detection index.

As described above, the detection process is performed based on the detection index that increases and decreases according to the relationship between the observation result of the messages and the reference information related to the observation result, and the detection index is reset when an extremum of the detection index has been detected. In this configuration, for example, in the case where an increasing/decreasing trend in the detection index is changed because an abnormal state in the network has been eliminated, the detection process can be performed based on the reset detection index. Thus, the elimination of the abnormal state in the network can be detected earlier, thereby inhibiting erroneous detection of an abnormality in the normal state where the abnormal state has been eliminated. Therefore, an abnormality in the network can be more accurately detected.
(2) In the above (1), the reference information may be reception intervals, of past messages, which are calculated based on the observation result. By using reception intervals of the messages calculated based on the observation result, and the reception intervals of the past messages, the calculation unit may calculate, as the detection index, for each message, a moving average value of the reception intervals of the messages. The moving average value increases and decreases according to a magnitude relationship between the reception intervals of the messages and the reception intervals of the past messages.

In this configuration, the detection index can be calculated through simple processing. In addition, since the detection process can be performed using the moving average value that tends to change according to occurrence of an abnormality in the network, occurrence of an abnormality can be detected early.
(3) In the above (2), the detection unit may determine that an abnormality occurs in the network, when the detection index is smaller than a predetermined threshold value. The reset unit may reset the detection index to be used in the detection process, when the reset unit has detected, as the extremum, a local minimum value of the detection index.

In this configuration, in the case where the moving average value is changed from the decreasing trend to the increasing trend because the abnormal state in the network has been eliminated, an abnormality in the network can be detected more accurately based on the reset moving average value.
(4) In the above (1), the reference information may be an average value of reception intervals of the messages. By using the reception intervals of the messages calculated based on the observation result, the average value, and a standard deviation of the reception intervals of the messages, the calculation unit may calculate, as the detection index, for each message, statistic values of the reception intervals of the messages, the statistic values increasing and decreasing according to a magnitude of a difference between the reception interval of the messages and the average value.

In this configuration, an abnormality in the network can be detected more accurately based on the statistic value indicating the degree of deviation from the average value, i.e., the normal value, of the reception intervals of the messages.
(5) In the above (4), the detection unit may determine that an abnormality occurs in the network, when the detection index is greater than a predetermined threshold value. The reset unit may reset the detection index to be used in the detection process, when the reset unit has detected, as the extremum, a local maximum value of the detection index.

In the above configuration, in the case where the statistic value is changed from the increasing trend to the decreasing trend because the abnormal state in the network has been eliminated, an abnormality in the network can be detected more accurately based on the reset statistic value.
(6) A detection method according to the embodiment of the present disclosure is a detection method in a detection device that detects an abnormality in a network in which a plurality of messages including a periodic message are transmitted and received. The detection method includes: calculating a detection index that increases and decreases according to a relationship between an observation result of the plurality of messages and reference information related to the observation result; performing a detection process of detecting an abnormality in the network, based on the calculated detection index; and monitoring the detection index, and resetting the detection index to be used in the detection process, upon detecting an extremum of the detection index.

As described above, the detection process is performed based on the detection index that increases and decreases according to the relationship between the observation result of the messages and the reference information related to the observation result, and the detection index is reset when an extremum of the detection index has been detected. In this method, for example, in the case where an increasing/decreasing trend in the detection index is changed because an abnormal state in the network has been eliminated, the detection process can be performed based on the reset detection index. Thus, the elimination of the abnormal state in the network can be detected earlier, thereby inhibiting erroneous detection of an abnormality in the normal state where the abnormal state has been eliminated. Therefore, an abnormality in the network can be more accurately detected.

Hereinafter, an embodiment of the present disclosure will be described with reference to the drawings. In the drawings, the same or corresponding parts are denoted by the same reference signs, and description thereof is not repeated. At least some parts of the embodiment described below may be combined as desired.

### [Configuration and Basic Operation]

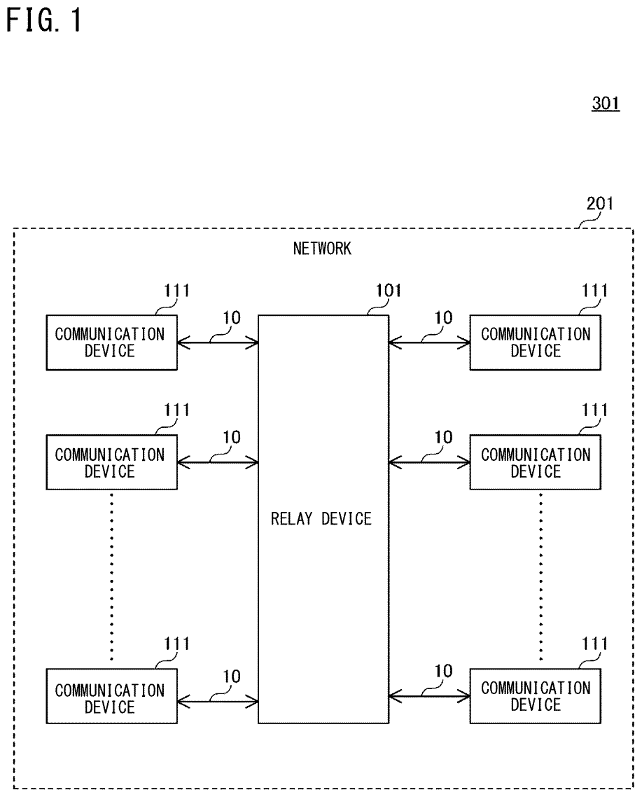

FIG. 1 shows a configuration of a communication system according to the embodiment of the present disclosure. With reference to FIG. 1, a communication system 301 includes a relay device 101 and a plurality of communication devices 111. The communication system 301 is installed in, for example, a vehicle. In this case, each of the communication devices 111 is, for example, an in-vehicle ECU (Electronic Control Unit).

The relay device 101 and the communication devices 111 constitute a network 201. More specifically, the relay device 101 and each communication device 111 are connected to each other via a transmission line 10. The transmission line 10 is, for example, a cable conforming to a standard such as CAN (Controller Area Network) (registered trademark), FlexRay (registered trademark), MOST (Media Oriented Systems Transport) (registered trademark), Ethernet, (registered trademark), or LIN (Local Interconnect Network).

The relay device 101 can communicate with the communication devices 111. The relay device 101 performs, for example, a relay process of relaying information that is exchanged between a plurality of communication devices 111 connected to different transmission lines 10.

In the network 201, a plurality of messages, including a message that is periodically transmitted, are transmitted and received.

More specifically, in the network 201, for example, a message is periodically transmitted from a communication device 111 to another communication device 111 via the relay device 101 according to a predetermined rule. Hereinafter, the message that is periodically transmitted in the network 201 is also referred to as a periodic message. The “periodic message” refers not only to a message that is strictly periodically transmitted but also to a kind of message that is to be periodically transmitted.

In the network 201, in addition to the periodic message, a message that is non-periodically transmitted from a communication device 111 to another communication device 111 via the relay device 101 exists. Hereinafter, the message that is non-periodically transmitted in the network 201 is also referred to as an event message.

Transmission of a message by the communication device 111 may be performed by any of broadcast, unicast, and multicast.

The relay device 101 functions as a detection device, and detects an abnormality in the network 201. For example, the relay device 101 detects presence of an unauthorized message in the network 201, as an abnormality in the network 201.

### [Relay Device]

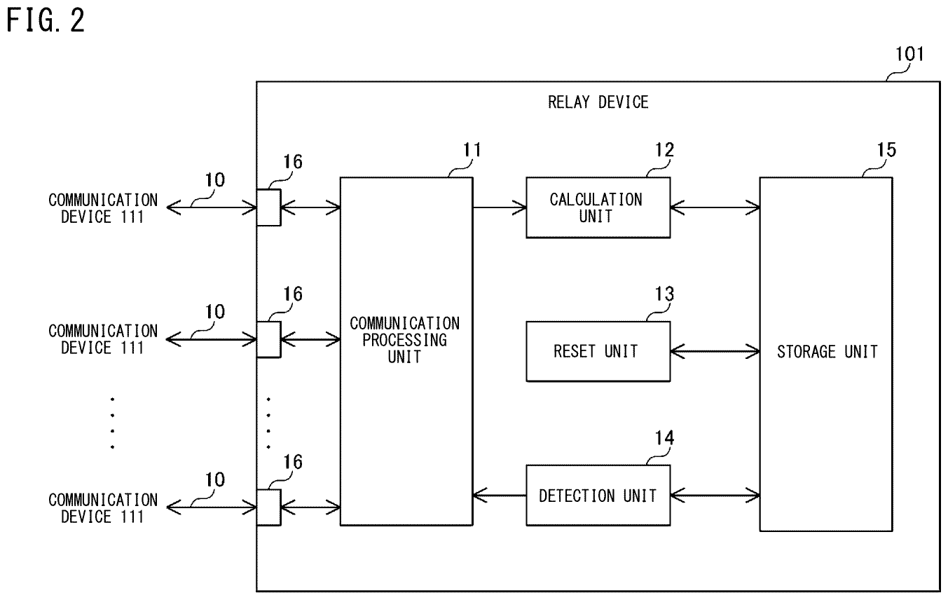

FIG. 2 shows a configuration of a relay device according to the embodiment of the present disclosure. With reference to FIG. 2, the relay device 101 includes a communication processing unit 11, a calculation unit 12, a reset unit 13, a detection unit 14, a storage unit 15, and a plurality of communication ports 16. Some or all of the communication processing unit 11, the calculation unit 12, the reset unit 13, and the detection unit 14 are realized by processing circuitry including one or more processors, for example. The storage unit 15 is, for example, a flash memory included in the processing circuitry. The communication ports 16 are, for example, connectors or terminals. A transmission line 10 is connected to each communication port 16.

The communication processing unit 11 performs a relay process of relaying a message being transmitted between the communication devices 111. For example, upon receiving a message from a communication device 111 via the corresponding transmission line 10 and the corresponding communication port 16, the communication processing unit 11 generates a message CP that is a duplicate of the received message, and adds a time stamp indicating the reception time of the message to the generated message CP. Then, the communication processing unit 11 transmits the received message to another communication device 111 via the corresponding communication port 16 and the corresponding transmission line 10, and outputs the message CP with the time stamp, to the calculation unit 12.

### (Calculation of Detection Index)

The calculation unit 12 calculates a detection index that increases and decreases according to the relationship between the reception time of a message and reference information related to the reception time. The reception time of the message is an example of an observation result of the message.

More specifically, the calculation unit 12 acquires a reception time t of a message to be subjected to a detection process in the relay device 101, among the messages that are relayed by the communication processing unit 11. Hereinafter, the message to be subjected to the detection process in the relay device 101 is also referred to as a target message. The target message may be one kind of message transmitted from a certain communication device 111, or may be a plurality of kinds of messages respectively transmitted from a plurality of communication devices 111. Hereinafter, a case where the relay device 101 performs the detection process with a message transmitted from a certain communication device 111 being a “target message M” will be described.

For example, the storage unit 15 has, stored therein, an ID for each kind of target message. Hereinafter, the ID of the target message M is also referred to as a target ID.

Upon receiving the message CP transmitted from the communication processing unit 11, the calculation unit 12 confirms the ID included in the received message CP and the target ID stored in the storage unit 15.

If the ID included in the message CP received from the communication processing unit 11 matches the target ID, the calculation unit 12 recognizes that the original message of the message CP is the target message M, and acquires the reception time t of the target message M with reference to the time stamp added to the message CP.

Upon acquiring the reception time t of the target message M, the calculation unit 12 calculates a difference between this reception time t and a reception time t of an immediately preceding target message M, as a reception interval x of the target message M. More specifically, the calculation unit 12 subtracts, from a reception time tm of an m-th target message Mm received by the communication processing unit 11, a reception time t(m−1) of an (m−1)th target message M(m−1) received by the communication processing unit 11 to calculate a reception interval xm of the target message Mm. Here, m is a positive integer. The calculation unit 12 stores the calculated reception interval xm in the storage unit 15.

The calculation unit 12 calculates a detection index by using the calculated reception interval x. For example, by using a standard deviation σ of the reception interval x, the calculation unit 12 calculates a statistic value T of the reception interval x for each target message M. The statistic value T indicates a degree of deviation of the reception interval x from a normal state. The statistic value T is an example of the detection index.

More specifically, with the calculated reception interval xm of the target message Mm, the calculation unit 12 calculates a degree of abnormality Dm of the target message Mm according to the following formula (1).

$$[ Math . 1 ]$$

$$Dm = {( \frac{xm - μ}{σ} )}^{2} \qquad ( 1 )$$

In formula (1), μ is an average value of reception intervals x, and an example of reference information related to the target message M. The standard deviation σ and the average value u are stored in the storage unit 15. For example, the standard deviation σ is calculated based on the reception interval x by a manufacturer of the communication system 301 in advance, and stored in the storage unit 15. For example, the average value u is a value calculated based on a design value of a transmission cycle of the target message M in the network 201 by the manufacturer of the communication system 301 in advance, and is stored in the storage unit 15. The calculation unit 12 may periodically or non-periodically calculate a standard deviation σ and an average value u based on a plurality of reception intervals x corresponding to a plurality of target messages M, and may update the standard deviation σ and the average value μ stored in the storage unit 15 to the calculated standard deviation σ and average value μ.

With the calculated degree of abnormality Dm of the target message Mm, the calculation unit 12 calculates a statistic value Tm of the target message Mm according to the following formula (2).

$$[ Math . 2 ]$$

$$Tm = max \{ 0 , ( T ( m - 1 ) + Dm - k ) \} \qquad ( 2 )$$

In formula (2), k is a limit parameter. The limit parameter k is a constant that is set in advance. As shown in formula (2), the statistic value Tm of the target message Mm is a value, which is obtained by subtracting the limit parameter k from the sum of a statistic value T(m−1) of the target message M(m−1) and the degree of abnormality Dm, or zero, whichever is greater.

As shown in formula (1) and formula (2), the statistic value Tm increases and decreases according to the magnitude of a difference between the reception interval xm of the target message Mm, and the average value μ. Specifically, if the degree of abnormality Dm becomes a value greater than the limit parameter k because the reception interval xm greatly deviates from the average value μ, the statistic value Tm of the target message Mm becomes greater than the statistic value T(m−1) of the immediately preceding target message M(m−1). Meanwhile, if the degree of abnormality Dm becomes a value smaller than the limit parameter k because the reception interval xm becomes a value close to the average value μ, the statistic value Tm of the target message Mm becomes zero, or a value smaller than the statistic value T(m−1) of the immediately preceding target message M(m−1).

The calculation unit 12 stores the calculated statistic value Tm in the storage unit 15.

### (Detection Process)

The detection unit 14 performs a detection process of detecting an abnormality in the network 201, based on the statistic value T calculated by the calculation unit 12. For example, the detection unit 14 detects presence of an unauthorized message in the network 201 as an abnormality in the network 201, based on the statistic value T calculated by the calculation unit 12 and a predetermined threshold value Thx.

More specifically, the detection unit 14 acquires the statistic value T calculated by the calculation unit 12 from the storage unit 15, and compares the acquired statistic value T with the threshold value Thx. If the statistic value T is not greater than the threshold value Thx, the detection unit 14 determines that no abnormality has occurred in the network 201. If the statistic value T is greater than the threshold value Thx, the detection unit 14 determines that an abnormality has occurred in the network 201.

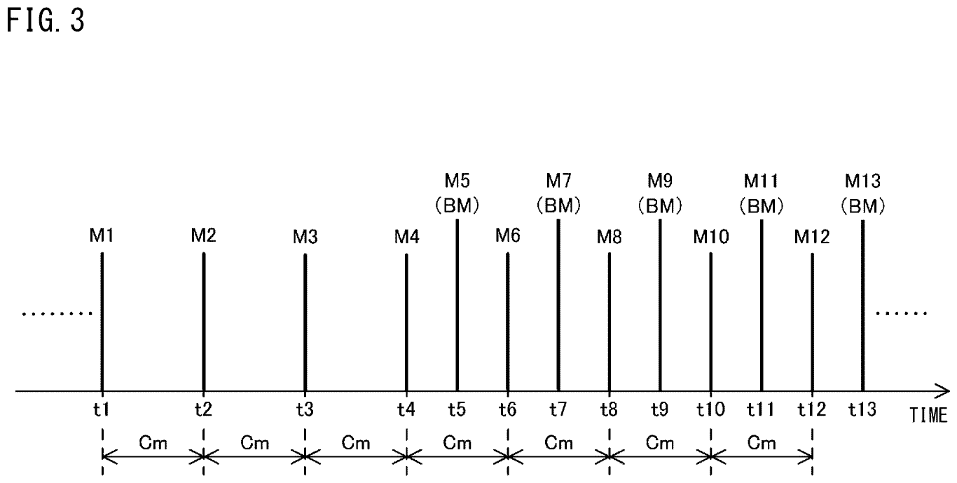

FIG. 3 shows an example of target messages received by the relay device according to the embodiment of the present disclosure, and a distribution of reception times. In FIG. 3, the horizontal axis represents time.

With reference to FIG. 3, a plurality of target messages M received by the communication processing unit 11 include: target messages M1 to M4, M6, M8, M10, M12 which are authorized periodic messages received at timings based on a predetermined transmission cycle Cm during a period from a reception time t1 to a reception time t12; and target messages M5, M7, M9, M11, M13 which are unauthorized messages BM received at timings based on the transmission cycle Cm, for example, during a period from a reception time t5 to a reception time t13. That is, during the period from the reception time 15 to the reception time t13, the authorized periodic messages and the unauthorized periodic messages alternately arrive at the relay device 101.

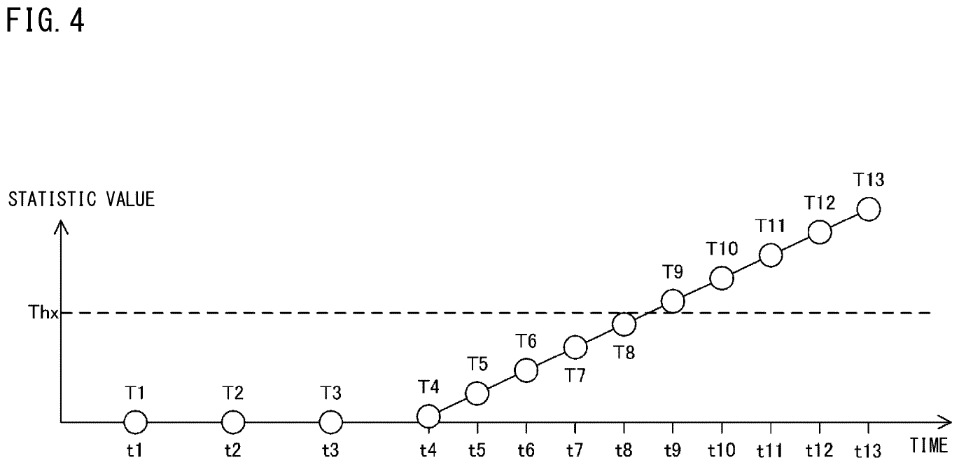

FIG. 4 shows an example of statistic values used for a detection process in the relay device according to the embodiment of the present disclosure. In FIG. 4, the horizontal axis represents time, and the vertical axis represents statistic value. Statistic values T1 to T13 shown in FIG. 4 are statistic values T that are calculated by the calculation unit 12 according to the above formula (2), based on the reception times t1 to t13 of the target messages M1 to M13 shown in FIG. 3.

With reference to FIG. 4, during a period from the reception time t1 to the reception time t4, only the authorized target messages M1 to M4 transmitted with the constant transmission cycle Cm are received by the communication processing unit 11, and the reception intervals x1 to x4 each have a value approximately equal to the average value μ. Therefore, the statistic values T1 to T4 calculated by the calculation unit 12 are zero.

Since the statistic values T1 to T4 calculated by the calculation unit 12 are not greater than the threshold value Thx, the detection unit 14 determines that no abnormality has occurred in the network 201 during the period from the reception time t1 to the reception time t4.

Meanwhile, in the period from the reception time t5 to the reception time t13, the unauthorized messages BM are received by the communication processing unit 11 in addition to the target messages M6, M8, M10, M12 transmitted with the transmission cycle Cm, and the reception intervals x5 to x13 each have a value deviated from the average value μ. Therefore, the statistic values T5 to T13 calculated by the calculation unit 12 gradually increase.

Since the statistic value T9 calculated by the calculation unit 12 exceeds the threshold value Thx, the detection unit 14 determines that an abnormality has occurred in the network 201 at the reception time t9. Upon determining the occurrence of the abnormality in the network 201, the detection unit 14 transmits warning information indicating the occurrence of the abnormality in the network 201 to a higher-order device located outside the communication system 301 via the communication processing unit 11. The higher-order device is, for example, a device such as a server that performs a predetermined process upon receiving the warning information.

Here, the threshold value Thx can be set to any value by a manufacturer of the network 201. For example, the threshold value Thx being set to a smaller value allows the detection unit 14 to determine occurrence of an abnormality in the network 201 at an earlier timing after transmission of an unauthorized message in the network 201 was started.

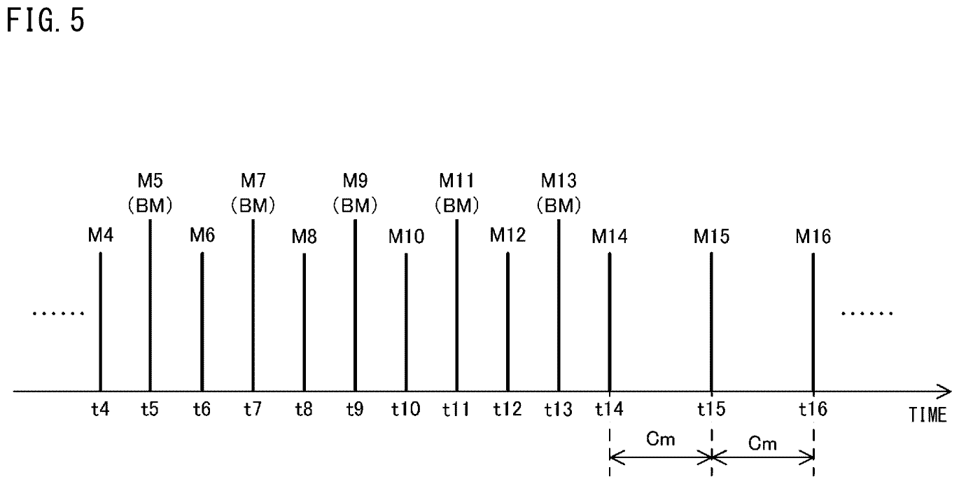

FIG. 5 shows an example of target messages received by the relay device according to the embodiment of the present disclosure, and a distribution of reception times. In FIG. 5, the horizontal axis represents time. FIG. 5 shows target messages M14 to M16 received by the communication processing unit 11 at reception times t14 to t16 after the reception time t13 shown in FIG. 3.

With reference to FIG. 5, the target messages M14 to M16 received by the communication processing unit 11 are authorized periodic messages transmitted with the transmission cycle Cm during a period from the reception time t14 to the reception time t16. That is, at the reception time t13, arrival of the unauthorized message at the relay device 101 has already ended.

### Problems

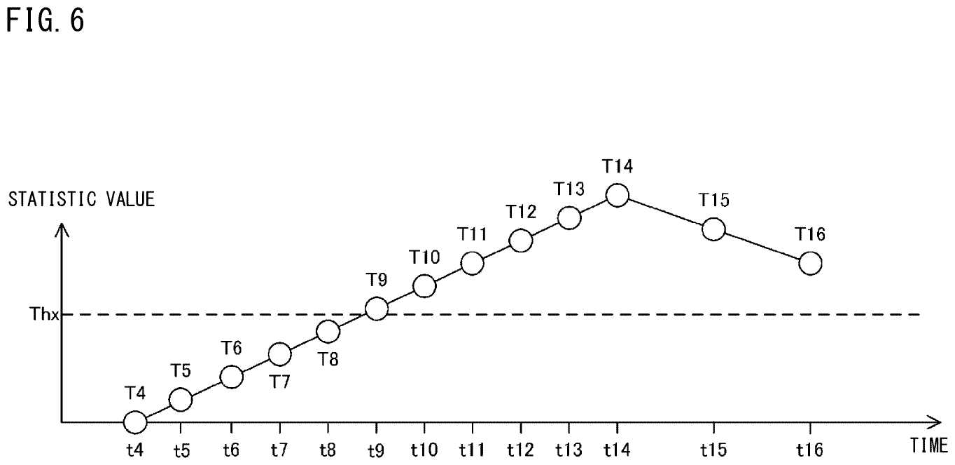

FIG. 6 shows an example of statistic values used for a detection process in a relay device according to a comparative example of the embodiment of the present disclosure. In FIG. 6, the horizontal axis represents time, and the vertical axis represents statistic value. Statistic values T4 to T16 in FIG. 6 are statistic values T that are calculated by the calculation unit 12 according to the above formula (2), based on the reception times t4 to t16 of the target messages M4 to M16 shown in FIG. 5.

With reference to FIG. 6, during the period from the reception time t14 to the reception time t16, only the authorized target messages M14 to M16 transmitted with the constant transmission cycle Cm arrive at the relay device, and therefore, the calculated statistic values T14 to T16 gradually decrease.

However, in the relay device according to the comparative example, since the statistic values T14 to T16 are greater than the threshold value Thx, the detection unit 14 determines that an abnormality is occurring in the network 201 not only in the period from the reception time 19 to the reception time t13 but also in a period on and after the reception time t14. That is, in the case of performing the detection process based on the statistic values T14 to T16, even though arrival of the unauthorized message has ended at the reception time t13 and an attack to the network 201 does not occur, the relay device according to the comparative example cannot detect the end of arrival of the unauthorized messages and determines that the abnormality in the network 201 continues.

The relay device 101 according to the embodiment of the present disclosure solves the above problem by using the following configuration.

### (Reset Process)

The reset unit 13 monitors the statistic values T, and upon detecting a local maximum value of the statistic values T, resets the statistic value T to be used in the detection process. For example, the reset unit 13 determines whether or not each statistic value Tis a local maximum value. When the reset unit 13 has determined that a statistic value T at a certain timing is a local maximum value and the statistic value T is greater than the threshold value Thx, the reset unit 13 resets the statistic value T at this timing to update the same.

For example, when a statistic value T has been stored in the storage unit 15 by the calculation unit 12, the detection unit 14 puts the detection process based on this statistic value T on standby until the reset unit 13 determines that this statistic value T is not a local maximum value, or the reset unit 13 updates this statistic value T. When the reset unit 13 has determined that the statistic value T is not a local maximum value and therefore need not be updated, the detection unit 14 performs the detection process based on this statistic value T. Meanwhile, when the statistic value T has been updated by the reset unit 13, the detection unit 14 performs the detection process based on the updated statistic value T.

Each time a statistic value T is determined not to be a local maximum value by the reset unit 13 or each time a statistic value T is updated by the reset unit 13, the detection unit 14 may sequentially perform the detection process based on this statistic value T. Alternatively, a predetermined number of statistic values T, which have been determined not to be a local maximum value by the reset unit 13 or have been updated by the reset unit 13, may be accumulated, and the detection unit 14 may perform the detection process afterward, based on the accumulated statistic values T.

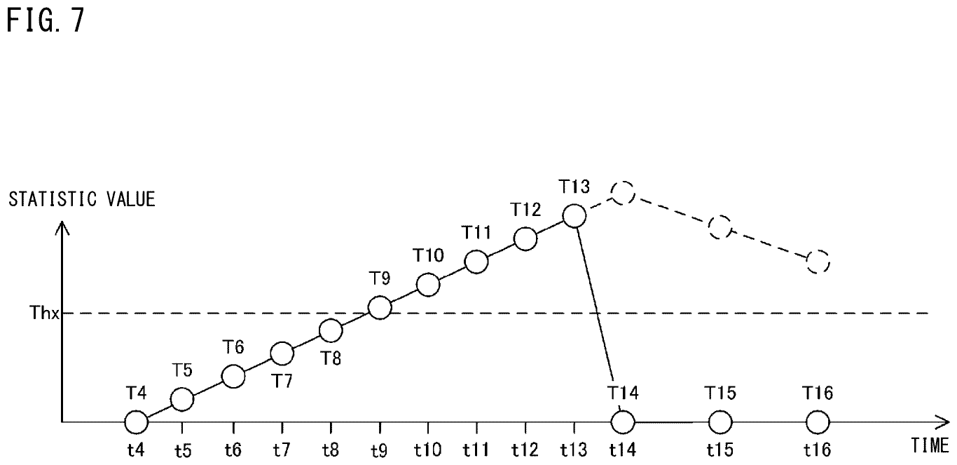

FIG. 7 shows an example of statistic values used for a detection process in the relay device according to the embodiment of the present disclosure. In FIG. 7, the horizontal axis represents time, and the vertical axis represents statistic value. Statistic values T4 to T13 shown in FIG. 7 are statistic values T that are calculated by the calculation unit 12 according to the above formula (2), based on the reception times t4 to t13 of the target messages M4 to M13 shown in FIG. 5. Statistic values T14 to T16 shown in FIG. 7 are statistic values T that are calculated by the calculation unit 12 according to the above formula (2), based on the reception times t14 to t16 of the target messages M14 to M16, and are updated by the reset unit 13.

With reference to FIG. 7, the reset unit 13 monitors the statistic values T stored in the storage unit 15 by the calculation unit 12. If two statistic values T, i.e., the statistic value T(m−1) and the statistic value Tm, continuously increase and two statistic values T, i.e., the statistic value T(m+1) and the statistic value T(m+2), continuously decrease, the reset unit 13 determines that the statistic value Tm is a local maximum value.

Specifically, with reference to the storage unit 15, the reset unit 13 determines that the statistic value T13 has increased from the statistic value T12, the statistic value T14 has increased from the statistic value T13, the statistic value T15 has decreased from the statistic value T14, and the statistic value T16 has decreased from the statistic value T15. Then, the reset unit 13 determines that the statistic value T14 is a local maximum value because the statistic values T13, T14 continuously increase and the statistic values T15, T16 continuously decrease.

Then, since the statistic value T14 determined to be the local maximum value is greater than the threshold value Thx, the reset unit 13 updates the statistic value T14 in the storage unit 15 to a reset value that is zero, for example. In addition, the reset unit 13 updates the other statistic values T15, T16, which have been calculated after the calculation timing of the statistic value T14 and are stored in the storage unit 15, based on the updated statistic value T14. More specifically, the reset unit 13 calculates a statistic value T15 according to the above formula (2), by using the updated statistic value T14.

Having the calculated statistic value T15, the reset unit 13 updates the statistic value T15 in the storage unit 15 to the calculated statistic value T15. Likewise, the reset unit 13 calculates a statistic value T16, and updates the statistic value T16 in the storage unit 15 to the calculated statistic value T16.

Since the statistic values T14 to T16 updated by the reset unit 13 are not greater than the threshold value Thx, the detection unit 14 determines that no abnormality has occurred in the network 201 during the period from the reception time t14 to the reception time t16. That is, the detection unit 14 determines that the abnormal state that started from the reception time t9 has ended by the reception time t13.

As described above, the detection unit 14 is configured to perform the detection process based on the reset statistic value T14. In this configuration, when arrival of the unauthorized message to the relay device 101 has ended, this end of arrival of the unauthorized message can be detected earlier than in the configuration in which the detection process is performed based on the statistic value T14 that is not reset, thereby inhibiting erroneous detection of an abnormality in the normal state in which the abnormal state has been eliminated.

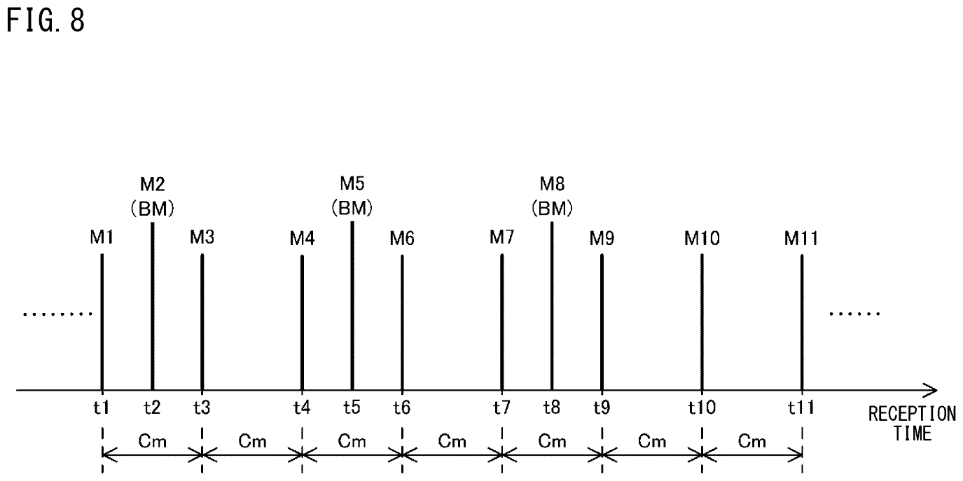

FIG. 8 shows another example of target messages received by the relay device according to the embodiment of the present disclosure, and a distribution of reception times. In FIG. 8, the horizontal axis represents time.

With reference to FIG. 8, a plurality of target messages M received by the communication processing unit 11 include: target messages M1, M3, M4, M6, M7, M9 to M11 which are authorized periodic messages received at timings based on the transmission cycle Cm during a period from the reception time t1 to the reception time t11; and target messages M2, M5, M8 which are unauthorized messages BM received at timings based on, for example, a cycle that is twice the transmission cycle Cm, during a period from the reception time t2 to the reception time t8.

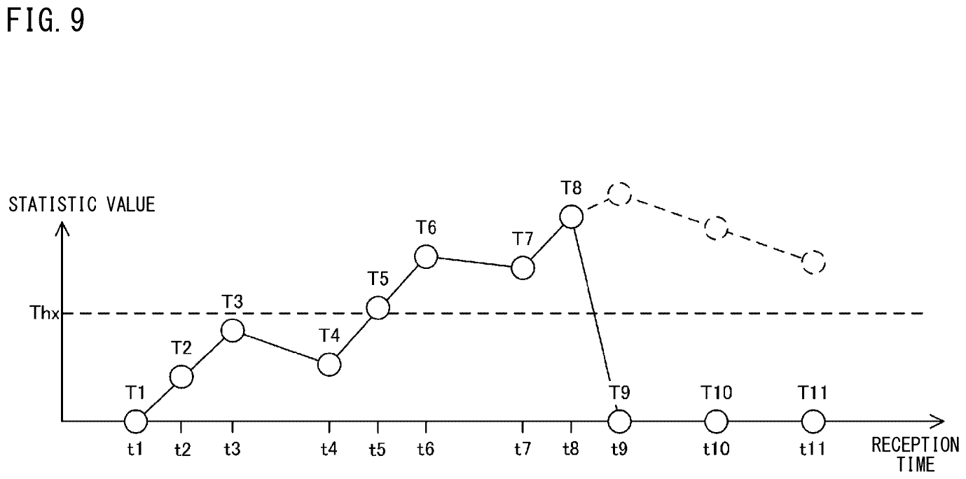

FIG. 9 shows an example of statistic values used for a detection process in the relay device according to the embodiment of the present disclosure. In FIG. 9, the horizontal axis represents time, and the vertical axis represents statistic value. Statistic values T1 to T8 shown in FIG. 9 are statistic values T that are calculated by the calculation unit 12 according to the above formula (2), based on the reception times t1 to 18 of the target messages M1 to M8 shown in FIG. 8. Statistic values T9 to T11 shown in FIG. 9 are statistic values T that are calculated by the calculation unit 12 according to the above formula (2), based on the reception times t9 to t11 of the target messages M9 to M11, and are updated by the reset unit 13.

With reference to FIG. 9, the unauthorized target message M2 is received by the communication processing unit 11 at the reception time t2 before passing of the transmission cycle Cm from the reception time t1 of the authorized target message M1, and the authorized target message M3 is received by the communication processing unit 11 at the reception time t3 after the passing of the transmission cycle Cm from the reception time t1. Therefore, the statistic values T2, T3 calculated by the calculation unit 12 gradually increase.

Next, the authorized target message M4 is received by the communication processing unit 11 at the reception time t4 after passing of the transmission cycle Cm from the reception time t3, and therefore, the statistic value T4 calculated by the calculation unit 12 decreases from the statistic value T3.

Next, the unauthorized target message M5 is received by the communication processing unit 11 at the reception time t5 before passing of the transmission cycle Cm from the reception time 14, and the authorized target message M6 is received by the communication processing unit 11 at the reception time to after the passing of the transmission cycle Cm from the reception time t4. Therefore, the statistic values T5, T6 calculated by the calculation unit 12 gradually increase, and exceed the threshold value Thx. Since the statistic value T5 calculated by the calculation unit 12 is greater than the threshold value Thx, the detection unit 14 determines that an abnormality has occurred in the network 201 at the reception time t5.

Next, the authorized target message M7 is received by the communication processing unit 11 at the reception time t7 after passing of the transmission cycle Cm from the reception time t6, and therefore, the statistic value T7 calculated by the calculation unit 12 decreases from the statistic value T6.

Next, the unauthorized target message M8 is received by the communication processing unit 11 at the reception time 18 before passing of the transmission cycle Cm from the reception time t7, and the authorized target message M9 is received by the communication processing unit 11 at the reception time 19 after the passing of the transmission cycle Cm from the reception time t7. Therefore, the statistic values T8, T9 calculated by the calculation unit 12 gradually increase.

Next, the authorized target message M10 is received by the communication processing unit 11 at the reception time t10 after passing of the transmission cycle Cm from the reception time t9, and the authorized target message M11 is received by the communication processing unit 11 at the reception time t11 after passing of the transmission cycle Cm from the reception time t10. Therefore, the statistic values T10, T11 calculated by the calculation unit 12 gradually decrease from the statistic value T9.

Since the statistic values T8, T9 continuously increase and the statistic values T10, T11 continuously decrease, the reset unit 13 determines that the statistic value T9 is a local maximum value. Then, since the statistic value T9 determined to be the local maximum value is greater than the threshold value Thx, the reset unit 13 updates the statistic value T9 to the reset value. Furthermore, the reset unit 13 updates the statistic value T10 calculated by the calculation unit 12 to a statistic value T10 calculated by using the updated statistic value T9, and updates the statistic value T11 calculated by the calculation unit 12 to a statistic value T11 calculated by using the updated statistic value T10.

Since the statistic values T9 to T11 updated by the reset unit 13 are not greater than the threshold value Thx, the detection unit 14 determines that no abnormality has occurred in the network 201 during the period from the reception time 19 to the reception time t11. That is, the detection unit 14 determines that the abnormal state that started from the reception time t5 has ended by the reception time t8.

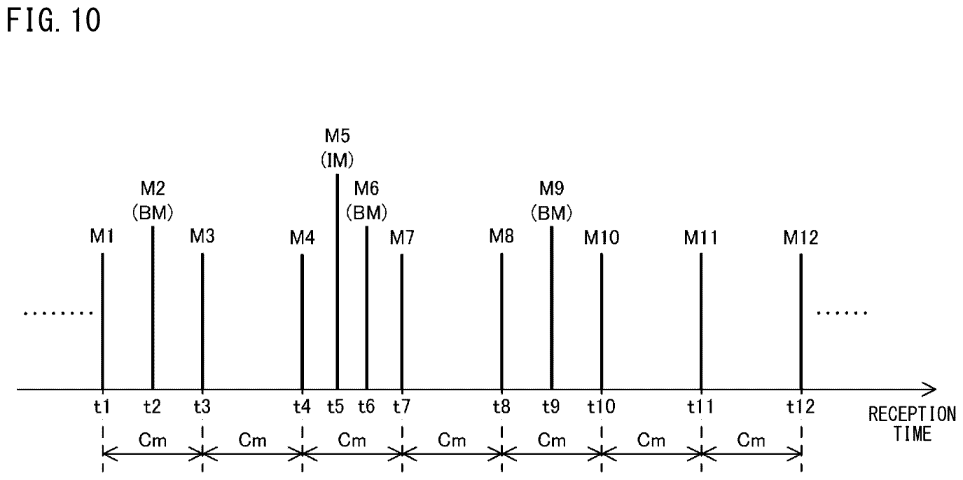

FIG. 10 shows another example of target messages received by the relay device according to the embodiment of the present disclosure, and a distribution of reception times. In FIG. 10, the horizontal axis represents time.

With reference to FIG. 10, a plurality of target messages M received by the communication processing unit 11 include: target messages M1, M3, M4, M7, M8, M10 to M12 which are authorized periodic messages received at timings based on the transmission cycle Cm during a period from the reception time t1 to the reception time t12; target messages M2, M6, M9 which are unauthorized messages BM received at timings based on, for example, a cycle that is twice the transmission cycle Cm, during a period from the reception time t2 to the reception time t9; and a target message M5 which is an event message IM transmitted at the reception time t5.

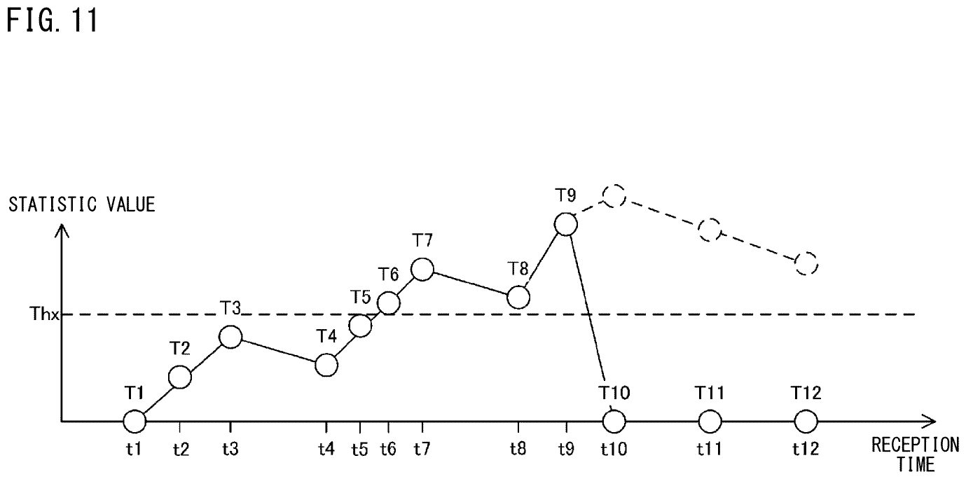

FIG. 11 shows an example of statistic values used for a detection process in the relay device according to the embodiment of the present disclosure. In FIG. 11, the horizontal axis represents time, and the vertical axis represents statistic value. Statistic values T1 to T9 shown in FIG. 11 are statistic values T that are calculated by the calculation unit 12 according to the above formula (2), based on the reception times t1 to t9 of the target messages M1 to M9 shown in FIG. 10. Statistic values T10 to T12 shown in FIG. 11 are statistic values T that are calculated by the calculation unit 12 according to the above formula (2), based on the reception times t10 to t12 of the target messages M10 to M12, and are updated by the reset unit 13.

With reference to FIG. 11, the unauthorized target message M2 is received by the communication processing unit 11 at the reception time t2 before passing of the transmission cycle Cm from the reception time t1 of the authorized target message M1, and the authorized target message M3 is received by the communication processing unit 11 at the reception time t3 after the passing of the transmission cycle Cm from the reception time t1. Therefore, the statistic values T2, T3 calculated by the calculation unit 12 gradually increase.

Next, the authorized target message M4 is received by the communication processing unit 11 at the reception time t4 after passing of the transmission cycle Cm from the reception time t3, and therefore, the statistic value T4 calculated by the calculation unit 12 decreases from the statistic value T3.

Next, the authorized target message M5 and the unauthorized target message M6, which are non-periodically transmitted, are received by the communication processing unit 11 at the reception times t5, t6 before passing of the transmission cycle Cm from the reception time t4, respectively, and the authorized target message M7 is received by the communication processing unit 11 at the reception time t7 after the passing of the transmission cycle Cm from the reception time t4. Therefore, the statistic values T5, T6, T7 calculated by the calculation unit 12 gradually increase, and the statistic values T6, T7 exceed the threshold value Thx. Since the statistic value T6 calculated by the calculation unit 12 is greater than the threshold value Thx, the detection unit 14 determines that an abnormality has occurred in the network 201 at the reception time t6.

Next, the authorized target message M8 is received by the communication processing unit 11 at the reception time 18 after passing of the transmission cycle Cm from the reception time t7, and therefore, the statistic value T8 calculated by the calculation unit 12 decreases from the statistic value T7.

Next, the unauthorized target message M9 is received by the communication processing unit 11 at the reception time t9 before passing of the transmission cycle Cm from the reception time t8, and the authorized target message M10 is received by the communication processing unit 11 at the reception time t10 after the passing of the transmission cycle Cm from the reception time t8. Therefore, the statistic values T9, T10 calculated by the calculation unit 12 gradually increase.

Next, the authorized target message M11 is received by the communication processing unit 11 at the reception time t11 after passing of the transmission cycle Cm from the reception time t10, and the authorized target message M12 is received by the communication processing unit 11 at the reception time t12 after passing of the transmission cycle Cm from the reception time t11. Therefore, the statistic values T11, T12 calculated by the calculation unit 12 gradually decrease from the statistic value T10.

Since the statistic values T9, T10 continuously increase and the statistic values T11, T12 continuously decrease, the reset unit 13 determines that the statistic value T10 is a local maximum value. Since the statistic value T10 determined to be the local maximum value is greater than the threshold value Thx, the reset unit 13 updates the statistic value T10 to the reset value. Furthermore, the reset unit 13 updates the statistic value T11 calculated by the calculation unit 12 to a statistic value T11 calculated by using the updated statistic value T10, and updates the statistic value T12 calculated by the calculation unit 12 to a statistic value T12 calculated by using the updated statistic value T11.

Since the statistic values T10 to T12 updated by the reset unit 13 are not greater than the threshold value Thx, the detection unit 14 determines that no abnormality has occurred in the network 201 during a period from the reception time t10 to the reception time t12.

### <Modifications>

The relay device 101 may be configured to perform a detection process based on a detection index other than the statistic value T. As an example, the calculation unit 12 calculates a detection index by using a moving average of reception intervals x of target messages M.

For example, the calculation unit 12 calculates, for each target message M, a moving average value A of reception intervals x of latest p target messages M received by the communication processing unit 11. Here, p is an integer not less than 2. The moving average value A is an example of the detection index.

More specifically, the calculation unit 12 calculates a reception interval xm of a target message Mm, and then calculates a moving average value Am corresponding to the target message Mm by using the reception interval xm, and reception intervals x(m−1), x(m−2), . . . x(m−p+1) of past target messages M(m−1), M(m−2), . . . , M(m−p+1). Here, the reception intervals x(m−1), x(m−2), . . . , x(m−p+1) are an example of the reference information related to the target message M. Hereinafter, the reception intervals x(m−1), x(m−2), . . . , x(m−p+1) are also referred to as reference intervals rm. The moving average value Am increases and decreases according to a magnitude relationship between the reception interval xm of the target message Mm, and the reference interval rm.

For example, when a plurality of target messages M received by the communication processing unit 11 include unauthorized messages BM as shown in FIG. 3, the moving average value A calculated by the calculation unit 12 gradually decreases during a period from the reception time t5 to the reception time t13.

The detection unit 14 performs a detection process based on the moving average value A calculated by the calculation unit 12. For example, the detection unit 14 detects an abnormality in the network 201, based on the moving average value A calculated by the calculation unit 12 and a predetermined threshold value Thy.

More specifically, the detection unit 14 compares the moving average value A calculated by the calculation unit 12 with the threshold value Thy. If the moving average value A is greater than or equal to the threshold value Thy, the detection unit 14 determines that no abnormality has occurred in the network 201. If the moving average value A is smaller than the threshold value Thy, the detection unit 14 determines that an abnormality has occurred in the network 201.

The reset unit 13 monitors the moving average value A, and upon detecting a local minimum value of the moving average value A, resets the moving average value A to be used in the detection process. For example, the reset unit 13 determines whether or not the moving average value A is a local minimum value in the same procedure as that for determining whether or not a statistic value Tis a local maximum value. When the reset unit 13 has determined that the moving average value A is a local minimum value and this moving average value A is smaller than the threshold value Thy, the reset unit 13 resets the moving average value A to update the same.

When the moving average value A has been updated by the reset unit 13, the detection unit 14 performs the detection process based on the updated moving average value A.

### [Operation Flow]

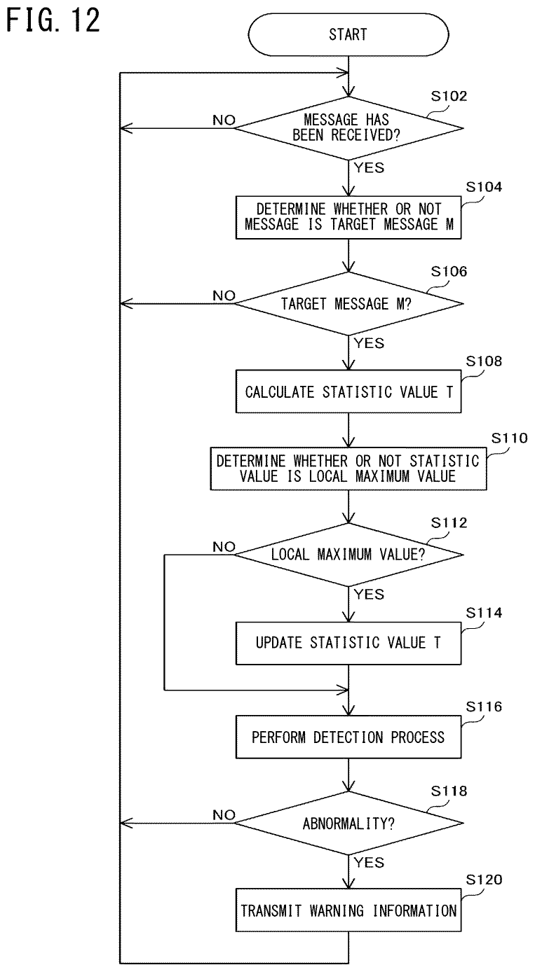

FIG. 12 is a flowchart showing an example of an operation procedure when the relay device according to the embodiment of the present disclosure performs a detection process.

With reference to FIG. 12, first, the relay device 101 waits for arrival of a message (NO in step S102). Upon receiving a message (YES in step S102), the relay device 101 determines whether or not the received message is a target message M(step S104).

Upon determining that the received message is not a target message M(NO in step S106), the relay device 101 waits for arrival of a new message (NO in step S102).

Meanwhile, upon determining that the received message is a target message M (YES in step S106), the relay device 101 calculates a statistic value T by using a reception time t of the target message M. The relay device 101 stores the calculated statistic value T in the storage unit 15 (step S108).

Next, the relay device 101 determines whether or not a statistic value T, which was calculated a predetermined number of times before, is a local maximum value (step S110).

Next, upon determining that the statistic value T calculated the predetermined number of times before is not a local maximum value (NO in step S112), the relay device 101 performs a detection process based on the statistic value T (step S116).

Meanwhile, upon determining that the statistic value T calculated the predetermined number of times before is a local maximum value (YES in step S112), the relay device 101 updates the statistic value T by resetting the same. In addition, the relay device 101 updates the other statistic values T, which have been calculated after the calculation timing of the above statistic value T and stored in the storage unit 15, based on the updated statistic value T (step S114).

Next, the relay device 101 performs a detection process based on the updated statistic value T (step S116).

Next, upon determining that no abnormality has occurred in the network 201 (NO in step S118), the relay device 101 waits for arrival of a new message (NO in step S102).

Meanwhile, upon determining that an abnormality has occurred in the network 201 (YES in step S118), the relay device 101 transmits warning information indicating the occurrence of the abnormality in the network 201 to the higher-order device located outside the communication system 301 (step S120).

Next, the relay device 101 waits for arrival of a new message (NO in step S102).

In the communication system 301 according to the embodiment of the present disclosure, the relay device 101 detects an abnormality in the network 201. However, the present disclosure is not limited thereto. In the communication system 301, a device different from the relay device 101 may function as a detection device to detect an abnormality in the network 201. For example, the communication system 301 includes a detection device connected to the relay device 101 via the transmission line 10. Upon receiving a message from the communication device 111, the relay device 101 transmits a mirror message, which is a duplicate of the received message, to the detection device via the transmission line 10. The detection device performs calculation of a detection index and a detection process, based on a reception time, in the relay device 101, of the mirror message received from the relay device 101.

In the communication system 301 according to the embodiment of the present disclosure, the relay device 101 that functions as a detection device is directly connected to the transmission line 10. However, the present disclosure is not limited thereto.

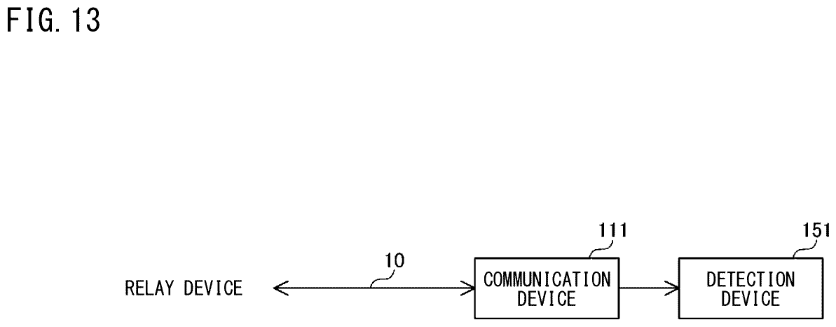

FIG. 13 shows an example of a connection topology of a network according to the embodiment of the present disclosure. With reference to FIG. 13, a detection device 151 may be connected to a transmission line 10 via the communication device 111. In this case, for example, the detection device 151 detects an abnormality in the network 201 by monitoring messages transmitted and received by the communication device 111. More specifically, the detection device 151 includes a calculation unit 12, a reset unit 13, a detection unit 14, and a storage unit 15. The calculation unit 12 in the detection device 151 acquires a reception time t of a target message M received by the communication device 111, and calculates a statistic value T, based on the acquired reception time t.

In the relay device 101 according to the embodiment of the present disclosure, the calculation unit 12 is configured to calculate a statistic value T of a reception interval x. However, the present disclosure is not limited thereto. For example, the calculation unit 12 may periodically or non-periodically calculate a communication load of a target message M, and calculate a detection index such as a statistic value T, based on the communication load instead of the reception interval x. The communication load is an example of a message observation result.

In the relay device 101 according to the embodiment of the present disclosure, the calculation unit 12 is configured to calculate a degree of abnormality Dm according to formula (1). However, the present disclosure is not limited thereto. For example, the calculation unit 12 calculates a degree of abnormality Dm according to formula (1) when the reception interval xm satisfies the following formula (3), whereas the calculation unit 12 determines a degree of abnormality Dm according to the following formula (5) when the reception interval xm satisfies the following formula (4).

$$[ Math . 3 ]$$

$${( xm - μ )}^{2} < {( n σ )}^{2} \qquad ( 3 )$$

$$[ Math . 4 ]$$

$${( xm - μ )}^{2} \geq {( n σ )}^{2} \qquad ( 4 )$$

$$[ Math . 5 ]$$

$$Dm = {n}^{2} \qquad ( 5 )$$

Here, n is a constant that is set in advance based on a frequency distribution of authorized periodic messages.

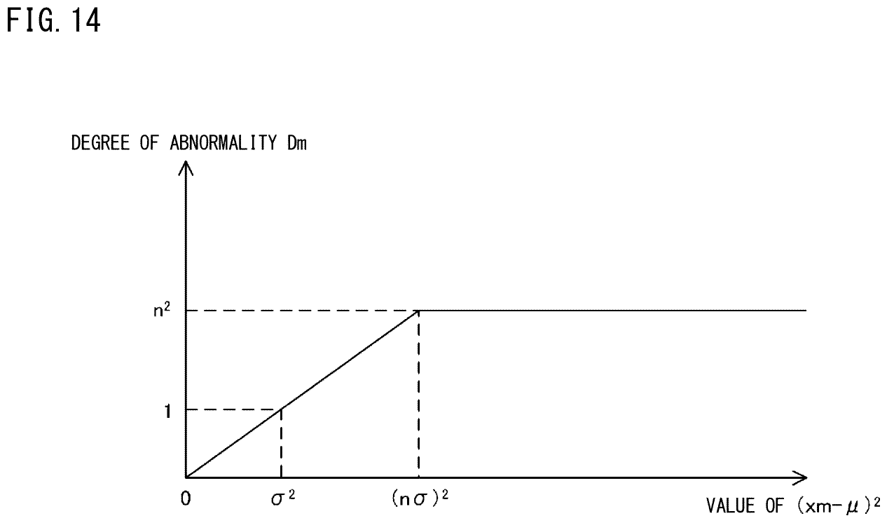

FIG. 14 shows an example of the degree of abnormality calculated by the calculation unit in the relay device according to the embodiment of the present disclosure. In FIG. 14, the horizontal axis represents the square of a difference between the reception interval xm and the average value μ, and the vertical axis represents the degree of abnormality Dm.

With reference to FIG. 14, since the calculation unit 12 is configured to calculate the degree of abnormality Dm according to formula (1) and formulae (3) to (5), even when the reception interval xm, of the target message Mm as an authorized event message received by the communication processing unit 11, greatly deviates from the average value μ, the degree of abnormality Dm of the target message Mm is a value not greater than the square of n. Therefore, a significant increase in the statistic value T due to arrival of the authorized event message can be inhibited, thereby inhibiting erroneous detection of an abnormality from occurring in the normal state where the abnormal state has been eliminated.

In the relay device 101 according to the embodiment of the present disclosure, the reset unit 13 is configured to determine that a statistic value Tm is a local maximum value, if two statistic values T, i.e., a statistic value T(m−1) and the statistic value Tm, continuously increase and two statistic values T, i.e., a statistic value T(m+1) and a statistic value T(m+2), continuously decrease. However, the present disclosure is not limited thereto. The reset unit 13 may determine that the statistic value Tm is a local maximum value, if a pieces of statistic values T from a statistic value T(m−a+1) to the statistic value Tm continuously increase and b pieces of statistic values T from a statistic value T(m+1) to a statistic value T(m+b) continuously decrease. Here, a and b are integers not less than 2.

Meanwhile, a technology enabling more accurate detection of an abnormality in a network has been desired.

To meet such a demand, in the relay device 101 according to the embodiment of the present disclosure, the calculation unit 12 calculates a detection index that increases and decreases according to the relationship between an observation result of target messages M and reference information related to the observation result. The detection unit 14 performs a detection process of detecting an abnormality in the network 201, based on the detection index calculated by the calculation unit 12. The reset unit 13 monitors the detection index, and resets the detection index to be used in the detection process, upon detecting an extremum of the detection index. Here, the extremum means a local maximum value or a local minimum value.

As described above, the detection process is performed based on the detection index that increases and decreases according to the relationship between the message observation result and the reference information related to the observation result, and the detection index is reset when an extremum of the detection index has been detected. In this configuration, for example, in the case where the increasing/decreasing trend in the detection index is changed because the abnormal state in the network 201 has been eliminated, the detection process can be performed based on the reset detection index. Thus, the elimination of the abnormal state in the network 201 can be detected earlier, thereby inhibiting erroneous detection of an abnormality in the normal state where the abnormal state has been eliminated. Therefore, an abnormality in the network 201 can be more accurately detected.

The above embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiment may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above description includes the features in the additional notes below.

### [Additional Note 1]

A detection device that detects an abnormality in a network in which a plurality of messages including a periodic message are transmitted and received, the detection device comprising:

a calculation unit configured to calculate a detection index that increases and decreases according to a relationship between an observation result of the plurality of messages and reference information related to the observation result;

a detection unit configured to perform a detection process of detecting an abnormality in the network, based on the detection index calculated by the calculation unit; and

a reset unit configured to monitor the detection index, and reset the detection index to be used in the detection process, upon detecting an extremum of the detection index, wherein
the calculation unit calculates the detection index that increases and decreases according to a relationship between a reception interval of the messages and reference information related to the reception interval.

### [Additional Note 2]

A detection device that detects an abnormality in a network in which a plurality of messages including a periodic message are transmitted and received, the detection device comprising processing circuitry,
the processing circuitry being configured to:
calculate a detection index that increases and decreases according to a relationship between an observation result of the plurality of messages and reference information related to the observation result;
perform a detection process of detecting an abnormality in the network, based on the calculated detection index; and
monitor the detection index, and reset the detection index to be used in the detection process, upon detecting an extremum of the detection index.

### REFERENCE SIGNS LIST

10 transmission line
11 communication processing unit
12 calculation unit
13 reset unit
14 detection unit
15 storage unit
16 communication port
101 relay device
111 communication device
151 detection device
201 network
301 communication system

1. A detection device that detects an abnormality in a network in which a plurality of messages including a periodic message are transmitted and received, the detection device comprising:
a calculation unit configured to calculate a detection index that increases and decreases according to a relationship between an observation result of the plurality of messages and reference information related to the observation result;
a detection unit configured to perform a detection process of detecting an abnormality in the network, based on the detection index calculated by the calculation unit; and
a reset unit configured to monitor the detection index, and reset the detection index to be used in the detection process, upon detecting an extremum of the detection index.

2. The detection device according to claim 1, wherein
the reference information is reception intervals, of past messages, which are calculated based on the observation result, and
by using reception intervals of the messages calculated based on the observation result, and the reception intervals of the past messages, the calculation unit calculates, as the detection index, for each message, a moving average value of the reception intervals of the messages, the moving average value increasing and decreasing according to a magnitude relationship between the reception intervals of the messages and the reception intervals of the past messages.

3. The detection device according to claim 2, wherein
the detection unit determines that an abnormality occurs in the network, when the detection index is smaller than a predetermined threshold value, and
the reset unit resets the detection index to be used in the detection process, when the reset unit has detected, as the extremum, a local minimum value of the detection index.

4. The detection device according to claim 1, wherein
the reference information is an average value of reception intervals of the messages, and
by using the reception intervals of the messages calculated based on the observation result, the average value, and a standard deviation of the reception intervals of the messages, the calculation unit calculates, as the detection index, for each message, statistic values of the reception intervals of the messages, the statistic values increasing and decreasing according to a magnitude of a difference between the reception interval of the messages and the average value.

5. The detection device according to claim 4, wherein
the detection unit determines that an abnormality occurs in the network, when the detection index is greater than a predetermined threshold value, and
the reset unit resets the detection index to be used in the detection process, when the reset unit has detected, as the extremum, a local maximum value of the detection index.

6. A detection method in a detection device that detects an abnormality in a network in which a plurality of messages including a periodic message are transmitted and received, the detection method comprising:
calculating a detection index that increases and decreases according to a relationship between an observation result of the plurality of messages and reference information related to the observation result;
performing a detection process of detecting an abnormality in the network, based on the calculated detection index, and
monitoring the detection index, and resetting the detection index to be used in the detection process, upon detecting an extremum of the detection index.
